(19) United States
(12) Patent Application Publication
(10) Pub. No.: US 2008/0019704 A1
(43) Pub. Date: Jan. 24, 2008

(54) INTERFEROMETER-BASED CHROMATIC DISPERSION MONITOR

(76) Inventor: ANTHONY L. CAMPILLO, Springfield, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 11/734,005

(22) Filed: Apr. 11, 2007

Related U.S. Application Data
(60) Provisional application No. 60/803,526, filed on May 31, 2006.

(51) Int. Cl. H04B 10/12; H04B 10/04

(52) U.S. Cl. 398/185

(57) ABSTRACT

An apparatus includes a first portion operable to convert an optical phase modulation component of a signal being transmitted through a fiber to a RF intensity modulation, the RF intensity modulation comprising a magnitude; and a second portion operable to determine a dispersion of the fiber based on the magnitude of the RF intensity modulation. Optionally, the first portion includes a path-imbalanced interferometer and an optical intensity detector communicating therewith. Optionally, the apparatus further includes a dispersion compensator communicating with the second portion. Optionally, the second portion includes a filter detector or a coherent detector. Optionally, the filter detector includes a bandpass filter and a Schottky diode, and the coherent detector includes a heterodyne detector or a homodyne detector.

### CROSS-REFERENCE TO RELATED APPLICATION

The application claims priority of U.S. Provisonal Patent Application Ser. No. 60/803,526, entitled “INTERFEROMETER BASED CHROMATIC DISPERSION MONITOR,” to Campillo.

### TECHNICAL FIELD

The present invention relates generally to a monitor of chromatic dispersion in optical fibers, and more particularly to a chromatic dispersion monitor for use in a system having a time varying dispersion.

### BACKGROUND ART

Chromatic dispersion in optical fibers causes a spreading of transmitted data pules. In long fiber spans, this spreading can lead to bit errors. To prevent these errors, dispersion compensating sections are added to the span. For systems with time varying dispersion, real-time monitoring and compensation is required.

Several methods have been developed for real time chromatic dispersion monitoring. One method for real-time chromatic dispersion monitoring involves monitoring tones added to the transmitted signal. Examples of this method include S. kuwahara et al., “Adaptive dispersion equalization by detecting dispersion fluctuations using PM-AM conversion, “Electron. Lett., vol. 34, no. 20, pp. 1956-1958. October 1998, incorporated herein by reference, and T. E. Dimmick et al., “Optical Dispersion Monitoring Technique Using Double Sideband Subcarriers,” IEEE Photon. Technol. Lett., vol. 12, no. 7, pp. 900-902, July 2000, incorporated herein by reference. However, in some systems practicing this method, extra tones added to the transmission result in spurious signals at the receiver. For this reason, techniques based on observing properties of the received data signal have been explored.

One direct method of observing properties of the received data signal involves monitoring the statistics of the received eye diagrams. Examples of this method include S. Ohteru et al., “Optical Signal Quality Monitor Using Direct Q-Factor Measurement,” IEEE Photon. Technol. Lett., vol. 11, no. 10, pp. 1307-1309, October 1999, incorporated herein by reference, and I. Shake et al., “Quality Monitoring of Optical Signals Influenced by Chromatic Dispersion in a Transmission Fiber Using Averaged Q-Factor Evaluation,” IEEE Photon Technol. Lett., vol 13, no. 4, pp. 385-387, April 2001, incorporated herein by reference. Systems that practice this method give information about dispersion as well as other sources of signal degradation, but require either long acquisition times or high speed sampling electronics.

Additional methods that observe properties of the transmitted signal are monitoring the regenerated clock signal such as discussed in Z. Pan et al., “Real-time group velocity dispersion monitoring and automated compensation without modifications of the transmitter,” Opt. Comm., vol. 230, pp. 145-149, 2004, incorporated herein by reference; using a two-photon absorber such as discussed in S. Wielandy et al., “Real time measurement of accumulated chromatic dispersion of automatic dispersion compensation,” Electron. Lett., vol. 38, no. 20, pp. 1198-1199, September 2002, incorporated herein by reference; and comparing the phases of optically filtered spectral components such as discussed in Q. Yu et al., “Chromatic Dispersion Monitoring Technique Using Sideband Optical Filtering and Clock Phase-Shift Detection,” J. Lightwave Technol., vol. 20, no. 12, December 2002, incorporated herein by reference, S. M. R. Motaghian Nezam et al., “Chromatic Dispersion Monitoring Using Partial Optical Filtering and Phase-Shift Detection of Bit Rate and Double Half Bit Rate Frequency Components,” Optical Fiber Communication Conference CD-ROM. Optical Society of America, Feb. 22-27, 2004, incorporated herein by reference. The aforementioned techniques have measurement ranges that depend on the clock rate, and therefore decrease with increasing data rates. The measurement range of a system based on monitoring the clock signal is limited to 900 ps/nm for 10 Gb/s non-return to zero (NRZ) signals and 640 ps/nm for 10 Gb/s return to zero (RZ) signals. Using a two photon absorber requires short pulses, limiting it s use to high data rate RZ systems. Monitoring optically filtered spectral components can provide a range of close to 1500 ps/nm, but requires stable, narrow-band, tunable filters as well as a stable transmitted wavelength.

### DISCLOSURE OF THE INVENTION

An embodiment of the invention includes a method including converting an optical phase modulation component of a signal being transmitted through a fiber to a RF intensity modulation; and determining a dispersion of the fiber based on a magnitude of the RF intensity modulation.

Optionally, the conversion of an optical phase modulation component of a signal being transmitted through a fiber to a RF intensity modulation includes converting the optical phase modulation component to an optical intensity modulation; and converting the optical intensity modulation to the RF intensity modulation. Optionally, the converting the optical phase modulation component to an optical intensity modulation includes using a path-imbalanced interferometer.

Optionally, the RF intensity modulation includes a frequency component magnitude; the determining of a dispersion of the fiber based on a magnitude of the RF intensity modulation includes comparing the frequency component magnitude with a reference; and the determination of the dispersion based on the comparing. Optionally, the dispersion is corrected based on the determining.

Another embodiment of the invention includes an apparatus. The apparatus includes a first portion operable to convert an optical phase modulation component of a signal being transmitted through a fiber to a RF intensity modulation, the RF intensity modulation comprising a magnitude; and a second portion operable to determine a dispersion of the fiber based on the magnitude of the RF intensity modulation.

Optionally, the first portion includes a path-imbalanced interferometer and an optical intensity detector communicating therewith.

Optionally, the apparatus further includes a dispersion compensator communicating with the second portion.

Optionally, the first portion comprises an optical amplifier. Optionally, the optical amplifier includes a fiber amplifier, a waveguide amplifier, or a bulk crystal amplifier. Optionally, the fiber amplifier includes a raman amplifier, an optical parametric amplifier, a doped amplifier, or a brillouin amplifier. Optionally, the waveguide amplifier includes a raman amplifier, an optical parametric amplifier, a doped amplifier, or a brillouin amplifier. Optionally, the bulk crystal amplifier includes a raman amplifier, an optical parametric amplifier, a doped amplifier, or a brillouin amplifier.

Optionally, the second portion includes a filter detector or a coherent detector. Optionally, the filter detector includes a bandpass filter and a RF detector, and the coherent detector includes a heterodyne detector or a homodyne detector. Optionally, the RF detector includes a Schottky diode, a current rectifier, a piece wise linear detector, a mean square power detector, or a logarithmic amplifier.

### BRIEF DESCRIPTION OF THE DRAWINGS

FIG. 1 is a schematic of an embodiment of the instant invention.

### BEST MODES OF CARRYING OUT THE INVENTION

An embodiment of the invention is based on the evolution of the RF spectrum of the transmitted data as it propagates along a dispersive fiber. For an intensity modulated double sideband (IM-DSB) signal transmitted along the fiber, dispersion converts some of the intensity modulated signal into phase modulation. Therefore, by measuring the phase modulation present at a specific spectral component, the dispersion of the link is determined. Such measurement is, for example, accomplished using an interferometer, such as a path imbalanced Mach-Zehnder interferometer (“MZI”).

The signal produced by the MZI is, for example, determined by considering the evolution of a spectral component at frequency Ω during propagation along the fiber. As the carrier (ω₀) and sidebands (ω₀±Ω) propagate along the fiber, they acquire phase shifts of φ₀ and φ_{±}, respectively. This produces an electric field with both intensity and phase modulation components at Ω. If the signal is then sent through an MZI with a path imbalance of τ, the electric field at the output of the MZI will be:

$${E}_{out} = \frac{1}{2} [ {A}_{0} cos ( {ω}_{0} t + {ϕ}_{0} ) \pm {A}_{0} cos ( {ω}_{0} t + {ϕ}_{0} + {ω}_{0} τ ) ] + \frac{1}{2} [ {A}_{Ω} cos ( {ω}_{0} t + Ω t + {ϕ}_{+} ) \pm {A}_{Ω} cos ( {ω}_{0} t + Ω t + {ϕ}_{+} + {ω}_{0} τ + Ωτ ) ] + \frac{1}{2} [ {A}_{Ω} cos ( {ω}_{0} t - Ω t + {ϕ}_{-} ) \pm {A}_{Ω} cos ( {ω}_{0} t - Ω t + {ϕ}_{-} + {ω}_{0} τ - Ωτ ) ] \qquad ( 1 )$$

The detected ac photocurrent for each output of the interferometer is then proportional to:

$${i}_{\pm } ∝ ( 1 \pm cos ( {ω}_{0} τ ) ) cos ( \frac{Ω r}{2} ) cos ( \frac{{ϕ}_{+} + {ϕ}_{-}}{2} ) cos ( Ω t + η ) + sin ( {ω}_{0} τ ) sin ( \frac{Ω τ}{2} ) sin ( \frac{{ϕ}_{-} + {ϕ}_{-}}{2} ) sin ( Ω t + η ) \qquad ( 2 )$$

Where η=(φ₊−φ₋)/2. For an interferometer biased at quadrature (ω₀τ=nπ/2), where n is an integer, the two outputs both have ac photocurrents proportional to:

$$i ∝ cos ( \frac{Ω τ}{2} ) cos ( \frac{{ϕ}_{-} + {ϕ}_{-}}{2} ) cos ( Ω t + η ) + sin ( \frac{Ω τ}{2} ) sin ( \frac{{ϕ}_{-} + {ϕ}_{-}}{2} ) sin ( Ω t + η ) \qquad ( 3 )$$

### Resulting in an RF power at Ω=π/τ of:

$$P ∝ {sin}^{7} ( \frac{{ϕ}_{-} + {ϕ}_{-}}{2} ) = {sin}^{2} ( \frac{{πλ}^{2} {f}_{RF}^{2}}{c} D ) \qquad ( 4 )$$

### Where λ is the optical wavelength. f_{RF}=Ω/2π, c is the speed of light in a vacuum, and D is the total accumulated dispersion of the link.

An embodiment of the invention includes a first portion operable to convert an optical phase modulation component of a signal being transmitted through a fiber to a RF intensity modulation, wherein the RF intensity modulation has a magnitude. The embodiment also includes a second portion operable to determine a dispersion of the fiber based on the magnitude of the RF intensity modulation.

Optionally, the first portion includes a path-imbalanced interferometer and an optical intensity detector communicating therewith. Optionally, the embodiment further includes a dispersion compensator communication with the second portion.

Optionally, the first portion comprises an optical amplifier. Optionally, the optical amplifier includes a fiber amplifier, a waveguide amplifier, or a bulk crystal amplifier. The bulk crystal includes, for example, doped glass and/or nonlinear crystal. Optionally, the fiber amplifier includes a raman amplifier, an optical parametric amplifier, a doped amplifier, or a brillouin amplifier. Optionally, the waveguide amplifier includes a raman amplifier, an optical parametric amplifier, a doped amplifier, or a brillouin amplifier. Optionally, the bulk crystal amplifier includes a raman amplifier, an optical parametric amplifier, a doped amplifier, or a brillouin amplifier.

Optionally, the second portion includes a filter detector and/or a coherent detector. For example, the filter detector includes a bandpass filter and a RF detector, and the coherent detector includes a heterodyne detector or a homodyne detector. For example, the RF detector includes a Schottky diode, a current rectifier, a piece wise linear detector, a mean square power detector, or a logarithmic amplifier.

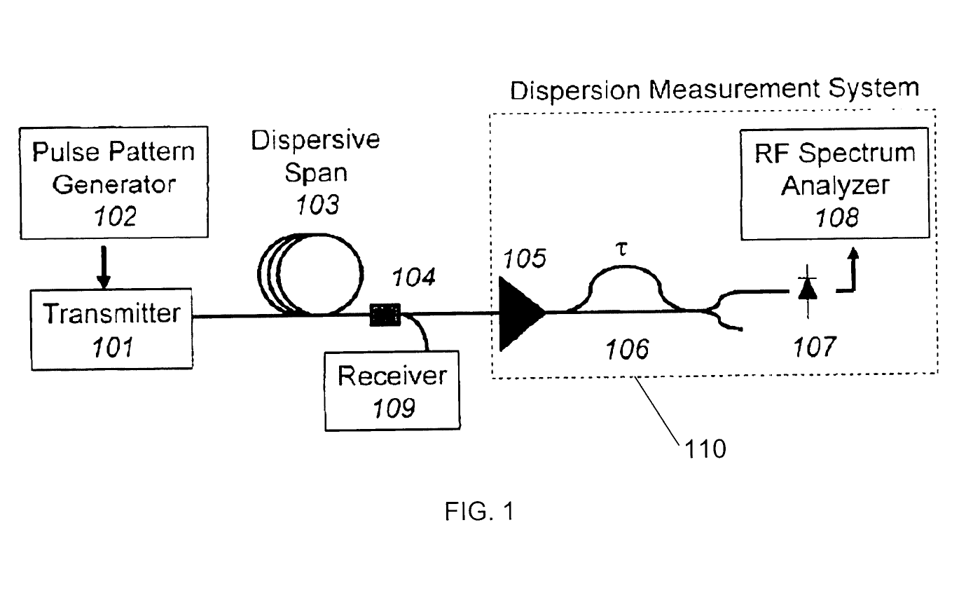

An embodiment of the invention is shown by way of example in FIG. 1. Using a transmitter 101, an optical carrier is modulated, for example, with a 10 Gb/s data pattern (i.e., a psuedorandom bit stream with pattern length 2²³−1), generated by a pulse pattern generator 302. The resulting signal is transmitted through a dispersive line 103. After transmission through the dispersive link 103, a portion of the transmitted signal is tapped using a fiber coupler/splitter 104 and sent to a dispersion measurement system 110. Because the magnitude of the measured RF power depends on the received photocurrent, the signal is first amplified with an erbium doped fiber amplifier 105. The signal is then transmitted through a fiber-based unbalanced MZI 106, for example, with a path-length difference of z=100 ps. The MZI is held at quadrature, for example, by adjusting the temperature of one arm. One output of the MZ is detected, for example, with a 20 GHz bandwidth photodiode 107. The RF power at 5 GHz is measured using a RF spectrum analyzer 108.

An embodiment of the invention provides a dispersion measurement range that is independent of the data rate, provided the transmitted signal has a frequency component at the monitored frequency. As a result, the same set up will provide the same measurement range, for example, for 10 Gb/s, 40 Gb/s, and higher data rates.

The chromatic dispersion measurement range of an embodiment of the instant invention is large. For example, by using an MZI with T=200 ps, a measurement range of greater than 15,000 s/nm is achievable.

In FIG. 1, one output of the interferometer is detected with a photodiode. In another embodiment of the invention, a balanced detection of both output could also be used.

The embodiment shown in FIG. 1 was described for intensity-modulated double sideband transmission. However, by monitoring the signal at f_{RF}=1/τ, instead of f_{RF}=1/(2τ), another embodiment of the invention employs a phase modulation format, such as DPSK.

Obviously, many modifications and variations of the present invention are possible in light of the above teachings without departing from the true scope and spirit of the invention. It is therefore to be understood that the scope of the invention should be determined by referring to the following appended claims.

What is claimed is:

1. A method comprising:
converting an optical phase modulation component of a signal being transmitted through a fiber to a RF intensity modulation; and
determining a dispersion of the fiber based on a magnitude of the RF intensity modulation.

2. The method according to claim 1, wherein said converting an optical phase modulation component of a signal being transmitted through a fiber to a RF intensity modulation comprises:
converting the optical phase modulation component to an optical intensity modulation; and
converting the optical intensity modulation to the RF intensity modulation.

3. The method according to claim 2, wherein said converting the optical phase modulation component to an optical intensity modulation comprises using a path-imbalanced interferometer.

4. The method according to claim 1, wherein the RF intensity modulation comprises a frequency component magnitude and wherein said determining a dispersion of the fiber based on a magnitude of the RF intensity modulation comprises:
comparing the frequency component magnitude with a reference; and
determining the dispersion based on said comparing.

5. The method according to claim 4, further comprising correcting the dispersion based on said determining.

6. An apparatus comprising:
a first portion operable to convert an optical phase modulation component of a signal being transmitted through a fiber to a RF intensity modulation, the RF intensity modulation comprising a magnitude; and
a second portion operable to determine a dispersion of the fiber based on the magnitude of the RF intensity modulation.

7. The apparatus according to claim 6, wherein said first portion comprises a path-imbalanced interferometer and an optical intensity detector communicating therewith.

8. The apparatus according to claim 6, further comprising a dispersion compensator communicating with said second portion.

9. The apparatus according to claim 6, wherein said first portion comprises an optical amplifier.

10. The apparatus according to claim 9, wherein said optical amplifier comprises one of a fiber amplifier, a waveguide amplifier, and a bulk crystal amplifier.

11. The apparatus according to claim 10, wherein said fiber amplifier comprises one of a raman amplifier, an optical parametric amplifier, a doped amplifier, and a brillouin amplifier.

12. The apparatus according to claim 10, wherein said waveguide amplifier comprises one of a raman amplifier, an optical parametric amplifier, a doped amplifier, and a brillouin amplifier.

13. The apparatus according to claim 10, wherein said bulk crystal amplifier comprises one of a raman amplifier, an optical parametric amplifier, a doped amplifier, and a brillouin amplifier.

14. The apparatus according to claim 6, wherein said second portion comprises at least one of a filter detector and a coherent detector.

15. The apparatus according to claim 14, wherein said filter detector comprises a bandpass filter and a RF detector, and wherein said coherent detector comprises one of a heterodyne detector and a homodyne detector.

16. The apparatus according to claim 15, wherein said RF detector comprises one of a Schottky diode, a current rectifier, a piece wise linear detector, a mean square power detector, and a logarithmic amplifier.
